(19) United States
(12) Patent Application Publication
(10) Pub. No.: US 2012/0200854 A1
(43) Pub. Date: Aug. 9, 2012

(54) Integrated Photonic Spectrograph

(76) Inventor: Joss Bland-Hawthorn, New South Wales (AU)

(21) Appl. No.: 13/502,023

(22) PCT Filed: Oct. 13, 2010
(86) PCT No.: PCT/AU2010/001343

§ 371 Date: Apr. 13, 2012

(30) Foreign Application Priority Data
Oct. 14, 2009 (AU) 2009904979

(51) Int. Cl. G01J 3/28; G01J 3/00

(52) U.S. Cl. 356/328; 356/300

(57) ABSTRACT

Described herein is a photonic spectrograph for accurately measuring and displaying spectra from radiation signals received from a telescope. One embodiment provides a photonic imaging device, in the form of a spectrograph, including a plurality of input ports for receiving an arbitrary incident electromagnetic radiation field containing one or more spatial propagation modes; a coupling device attached to the multi-mode optical fibre for efficiently coupling the incident electromagnetic radiation field into an arbitrary plurality (N) of single-mode optical fibres; an optical manipulation device which selectively combines the single-mode signals into a continuous optical spectrum; and an optical detector for detecting the continuous optical spectrum.

### CROSS REFERENCE TO RELATED APPLICATIONS

This application is the National Stage of International Application No. PCT/AU2010/001343, filed Oct. 13, 2010, which claims priority to prior Australian application number 2009904979, filed Oct. 14, 2009.

### FIELD OF THE INVENTION

The present invention relates to optical signal analysis and in particular to an optical spectrograph for displaying radiation spectra received from a source such as a telescope. While some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

A fundamental characteristic of an optical system is its ability to resolve an angular (spatial) or spectral element. In an optical system where étendue (i.e. area-solid angle—AΩ) is conserved throughout, the angular resolution limit is ultimately fixed by the number of wavelengths (fringes) across the first optical element (diameter Dₜₑₗ). That is, the system is diffraction limited. This occurs as an instrument can only ever collect a portion of an incident wavefront. As such, diffraction will inevitably occur as light will deviate from straight-line propagation and spread out somewhat in the image plane. The result is that the instrument forms an image having a finite spot size or point spread function (PSF), rather than an ideal point.

The limiting wavelength resolution of a spectrograph (δλ) used in the first order of interference is set by the number of fringes across the illuminated region of the dispersing element (diameter Dₚᵤₚ). In a catadioptric (combination of reflecting and refracting elements) “focal reducer” arrangement the disperser is placed at the pupil between a collimator lens (diameter D_{coll}), and a camera lens (diameter D_{com}) that reverses the action of the collimator, to form an image at the detector.

The ideal resolving power R of any dispersing element can generally be expressed as:

$$R = \frac{λ}{δλ} = mN \qquad ( 1 )$$

where N is the number of combining beams (or finesse) and m is the spectral order of interference. However, this ideal limit is only achieved in practice for diffraction-limited instruments, and in the limit of low N, in particular for the Michelson interferometer and its variants.

A simple example serves to demonstrate how far astronomical instruments fall short of this ideal. Consider a spectrograph with a grating line density of ρ=1000 lines min⁻¹ placed at a pupil with diameter, say, Dₚᵤₚ=50 mm. In a perfect system, for a flat pupil illumination, the peak spectral resolving power is R=mρDₚᵤₚ=50,00, where the minimum configuration for which m=1 is adopted. Diffraction-limited

$$\frac{\hat{J}}{4}$$

optical lenses (focal ratio F−4) are commercially available such that, for an ideal system, the overall length of the instrument is of order L=4FDₚᵤₚ, or about 0.8 m in length. This is much smaller than any contemporary high-performance spectrograph working at high resolution and, furthermore, these instruments operate typically at m>1 to achieve higher resolving power.

The importance of striving for an ideal system can be seen by expressing the resolving power as R=ε [symbol] mN where ε is the factor ( [symbol] ε<1) by which a spectrograph falls short of the ideal in terms of the number of combining beams that are available to the designer in a diffraction-limited system. An ideal instrument can be made a factor of

$$\frac{1}{ɛ}$$

smaller in linear extent to achieve a given resolving power R. A review of widely-used, seeing-limited spectrographs at major observatories reveals that ε [symbol] ˜0.03−0.03 in general.

As indicated above, in conventional spectrographs, the physical size of the entrance aperture that accepts light from a source determines the ultimate spectroscopic resolution

$$( R = \frac{λ}{δλ} )$$

of a spectrograph. To achieve the highest resolutions, in conventional applications, two options are available: (a) make the instrument physically very large (i.e. tens of metres; e.g. the HIRES echelle spectrograph on the Keck Telescope in Hawaii), or (b) make the entrance aperture very narrow (i.e. of order microns). Consequently, conventional astronomical spectrographs are normally very large and use bulk optics.

An example of case (b) is the Ocean Optics HR4000 spectrometer that achieves its highest resolutions (R=4000) with a 5 μm slit width, i.e. single mode input. These devices are only useful when a bright source (e.g. laser) is shone directly onto the extremely narrow entrance aperture.

### SUMMARY OF THE INVENTION

It is an object of the invention, to provide an improved photonic spectrograph.

In accordance with a first aspect of the present invention there is provided a photonic imaging device including:

an input port for receiving an arbitrary incident electromagnetic radiation field containing one or more spatial propagation modes;

a coupling device attached to the at least one input port for efficiently coupling the incident electromagnetic radiation field into a plurality (N) of single-mode optical fibres;

an optical manipulation device adapted to receive the optical signals output from the single-mode fibres and selectively combine the single-mode signals into a continuous optical spectrum; and

an optical detector for detecting the continuous optical spectrum.

In preferred embodiments, the plurality (N) of single-mode fibres is greater than or equal to the number of spatial modes supported in the incident radiation field.

The input port and coupling device preferably together define a photonic lantern having a multi-mode input and N single-mode outputs.

In one embodiment the photonic imaging device preferably further includes:

a plurality of photonic lanterns arranged in a bundle array, each lantern being coupled to N single-mode fibres; and

a corresponding plurality of optical manipulation devices for respectively combining each group of N single-mode fibres output from each photonic lantern, thereby defining an array of continuous spectra to be detected by the optical detector. The plurality of photonic lanterns and optical manipulation devices are preferably stacked in a vertically disposed array.

In one embodiment the optical manipulation device is preferably an array waveguide grating having N input ports. In an alternative embodiment the optical manipulation device preferably includes:

a diffraction-limited slit adapted to receive the optical signals output from the single-mode fibres; and

a diffraction grating adapted to receive the optical signals transmitted through the diffraction slit.

In this latter embodiment the photonic imaging device preferably further includes an incoherent array waveguide coupled between the outputs of the N single-mode fibres and the input of the diffraction slit for reducing the spacing of the optical signals propagating in the single-mode fibres. The output ports of the incoherent array waveguide are preferably spaced apart by a distance of about one free spectral range. The free spectral range preferably corresponds to a distance of about 2 mm

The photonic imaging device preferably further includes one or more dispersing elements inserted between the output of the optical manipulation device and the detector for spatially separating wavelength bands contained within the incident electromagnetic radiation field. These dispersing elements preferably include a micro cylinder and a micro prism. The photonic imaging device preferably further includes an OH suppression fibre Bragg grating inserted between the output of the coupling device and the input of the single-mode fibres.

Preferably the N single-mode fibres are contained in a ribbon cable. The optical detector preferably includes a plurality of individual pixel elements, each having a size of less than about 2 microns. In one embodiment the optical detector is preferably a charge-coupled device (CCD) detector. Ideally, a very high resolution pixel sensing pitch is used with the detector device.

Throughout this specification, unless specifically stated otherwise, use of the terms “optical”, “optical signal”, “light”, “light signal” and the like refer to electromagnetic radiation in one or more of the infrared, visible and ultra-violet wavelength ranges.

Throughout this specification, unless specifically stated otherwise, use of the terms “system” or “optical system” refer to the system within the spectrograph defined by the various optical and photonic elements. The term “optical path” refers to the path that the optical signal traverses through the system and various elements.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 is a schematic view of a spectrograph according to one embodiment;

FIG. 2 is a schematic view of a spectrograph according to a second embodiment;

FIG. 3 is a schematic view of a spectrograph according to a third embodiment;

FIG. 4 is a longitudinal cross-sectional view of a photonic lantern;

FIG. 5 is an illustration of the mode propagation inside a photonic lantern;

FIG. 6a is an axial cross-sectional view of a the photonic lantern of FIG. 4 along plane A;

FIG. 6b is an axial cross-sectional view of the photonic lantern of FIG. 4 taken along plane B;

FIG. 6c is an axial cross-sectional view of the photonic lantern taken along plane C;

FIG. 7 is a schematic illustration of an incoherent array waveguide;

FIG. 8 is a side perspective view of the spectrograph showing the optical signals exiting the array waveguide grating, being dispersed by the micro cylinder and micro lens and being incident on the detector; and

FIG. 9 is a rear perspective view of the spectrograph according to one embodiment having a plurality of array waveguide gratings disposed in a vertical stack.

### DETAILED DESCRIPTION

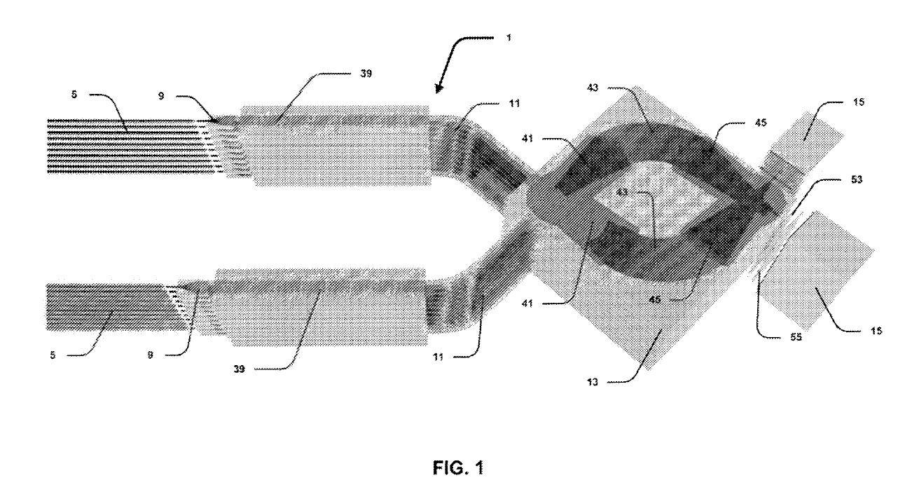

Turning initially to FIG. 1, described herein is a photonic spectrograph 1 for accurately measuring and displaying spectra from radiation signals received from a telescope 3. One embodiment provides a photonic imaging device, in the form of a spectrograph 1, including a plurality (hereinafter denoted M) of input ports in the form of multi-mode optical fibres 5. The optical fibres 5 are adapted for receiving an arbitrary incident electromagnetic radiation field 7 containing one or more spatial propagation modes such as an optical signal from a telescope. The spectrograph 1 includes a coupling device in the form of a photonic lantern 9 attached to the multi-mode optical fibre 5 for efficiently coupling the incident electromagnetic radiation field into an arbitrary plurality (hereinafter denoted N) of single-mode optical fibres 11 for diffraction-limited single-mode propagation. The plurality, N, of single-mode fibres 11 is greater than or equal to the number of spatial modes supported in the incident radiation field such that efficient coupling is achieved. The single-mode optical signals output from the single-mode fibres 11 are received by an optical manipulation device in the form of an array waveguide grating 13 which selectively combines the single-mode signals into a continuous optical spectrum. An optical detector 15 is provided for detecting the continuous optical spectrum output from the array waveguide grating 13.

In an alternative embodiment, the spectrograph 1 of FIG. 1 is not a stacked instrument and includes only a single input multi-mode fibre 5, photonic lantern 9, array waveguide grating 13. In this embodiment, the detector 15 can be reduced in size.

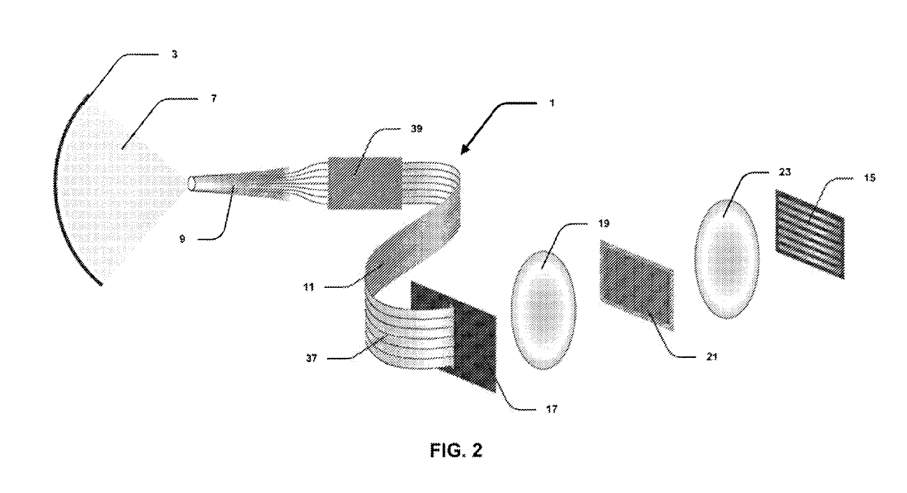

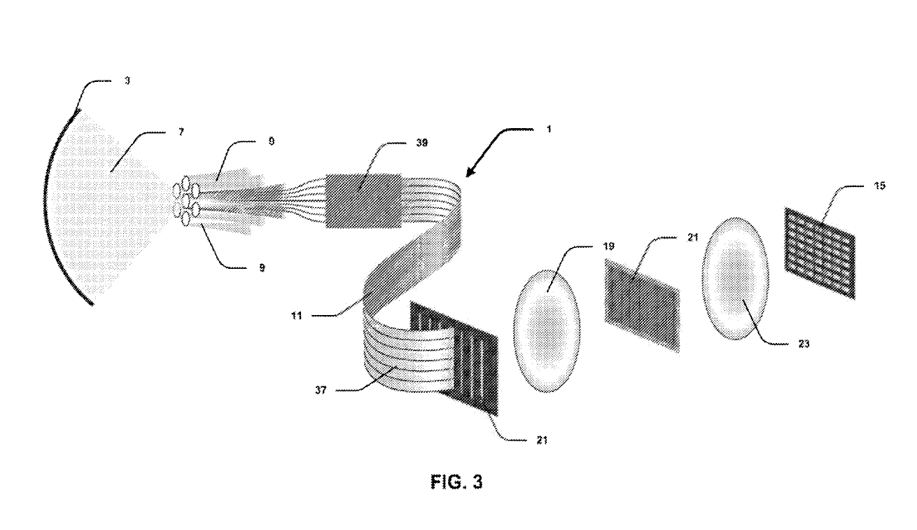

Further alternative embodiments of the present invention are shown in FIGS. 2 and 3. In these embodiments, the array waveguide grating 13 has been replaced with diffraction-limited optics, in the form of a diffraction slit 17 and a collimator 19 feeding a conventional diffraction grating 21. A similar diffraction slit can be implemented into the embodiment of FIG. 1. The collimated light can be incident on the grating 21 at substantially any angle. In an embodiment, the angle of incidence of collimated light onto the grating is about 45°. This provides an even bigger number of combining beams across the pupil. Furthermore, the diffraction grating 21 can be either a transmission or reflection grating.

FIG. 2 shows a device adapted to receive incident radiation into a single photonic lantern 9, while FIG. 3 shows a device adapted to receive incident radiation into a plurality of photonic lanterns 9 arranged into an array. In this latter embodiment, the optical signal output from each photonic lantern is coupled into N single-mode optical fibres. In the embodiments of FIGS. 2 and 3, a lens 23 and/or camera element is used to focus the diffracted signal onto the detector 15.

Incident Radiation

Electromagnetic radiation is received by a telescope or other collecting device and coupled into one or more multi-mode optical fibres 5. In one embodiment the telescope is an optical telescope 3 for receiving at least infrared, visible and ultra-violet signals. However, in alternative embodiments, other types of telescopes are used.

In the preferred embodiment the incident radiation signal 7 is unfiltered and coupled directly from the telescope into the spectrograph 1. In alternative embodiments, the signal is filtered prior to coupling to the spectrograph such that only a predetermined spectrum is analysed by the device. In further embodiments, other signal manipulations such as polarization and collimation can be performed on the incident radiation 7.

The incident radiation 7 contains one or more polarized or unpolarized spatial propagation modes. Examples of the incident radiation 7 include optical signals from distant stars and other astronomical spectra combined with various noise signals.

Optical Fibre Propagation

By and large, observational astronomy requires the use of large-core multi-mode optical fibres to increase the étendue of the optical system. These large core multi-mode fibres support a number of unpolarized modes, which has deterred the use of more complex photonic functions that are exclusively limited to single-mode propagation.

On the other hand, the spot size of a point source imaged through a perfect telescope is theoretically independent of the telescope diameter (λF μM—ignoring factors of order of unity). Therefore, at a fixed wavelength λ, the unpolarised diffraction-limited image is single-moded depending only on the focal ratio F. Thus, in principle, a diffraction-limited beam can be coupled efficiently to the front face of a single-mode fibre.

Realizing these factors together, the present invention provides the advantages of a diffraction-limited instrument in the presence of an incoherent or aberrated source of illumination from a telescope.

Any pipe or conduit that guides a flow (light, fluid, gas) accommodates a family of propagating waves within that medium. Consider light guided by a silica step-index optical fibre, consisting of a core of radius a, with uniform refractive index n surrounded by cladding material of uniform index n₂<n₁. In the limit of

$$Δ = \frac{{n}_{1} \text{?} {n}_{2}}{{n}_{2}} << 1 , \\ \text{?} \text{indicates text missing or illegible when filed}$$

the propagating modes of such a fibre have a particularly simple form. In the so-called weakly-guiding limit, Maxwell's equations can be transformed into a scalar wave equation for the longitudinal components, and the fields within the fibre can be expressed as a series of linearly polarised (LP) modes.

The LP modes are characterised by two numbers, the azimuthal order, l, and the radial order, m. The transverse component of the electric field of the LPₗₘ mode is given by:

$$\begin{matrix}{E}_{l m} ( ρ , θ ) = \frac{{A}_{l m} ( sin l θ , cos l θ ) {J}_{l} ( {u}_{l m} ρ )}{{J}_{l} ( {u}_{l m} )} core ( ρ \leq 1 ) & ( 2 ) \\ {E}_{l m} ( ρ , θ ) = \frac{{A}_{l m} ( sin l θ , cos i θ ) {K}_{l} ( {v}_{l m} ρ )}{{K}_{l} ( {v}_{l m} )} core ( ρ \geq 1 ) & ( 3 )\end{matrix}$$

where ρ=r/a) is the normalized radial coordinate, J is the Bessel function of the 1^{st} kind, K is the modified Bessel function of the 2^{nd} kind and A is an amplitude coefficient. The longitudinal components are small by a factor of order (2 [symbol] Δ)^{-0.5} and can be neglected. The constants uₗₘ and vₗₘ are determined from the m^{th} root of the following equation:

$$u \frac{{J}_{l - 1} ( u )}{{J}_{l} ( u )} + v \frac{{K}_{l - 1} ( v )}{{K}_{l} ( v )} = 0 \qquad ( 4 )$$

where uₗₘ is bounded by the m^{th} zero of lₗ₋₁ and the m^{th} zero of h. The normalised frequency V of the fibre is defined by:

$$V - \frac{2 π}{λ} aNA - \sqrt{{u}^{2} + {v}^{2}} \qquad ( 5 )$$

where NA= [symbol] \sqrt{(n₁²−n₂²)}≈ [symbol] n₂ [symbol] \sqrt{2Δ} is the numerical aperture of the fibre. For a mode to be guided by the fibre vₗₘ must be real, and so the minimum value of uₗₘdefines the cut-off frequency Vc for the mode. In the special case of l=0, the rr=1 mode has a cut-off frequency of zero, which is the fundamental mode of the fibre and is always present. The cut-off frequencies of the LP modes become more closely spaced at higher frequencies such that the number of guided modes at a normalised frequency V is approximately proportional to V².

Thus, propagation of electromagnetic radiation in a multi-mode optical fibre can be described by a set of transverse spatial modes where the number of modes increases with the radial geometric size and material properties of the fibre.

Photonic Lantern

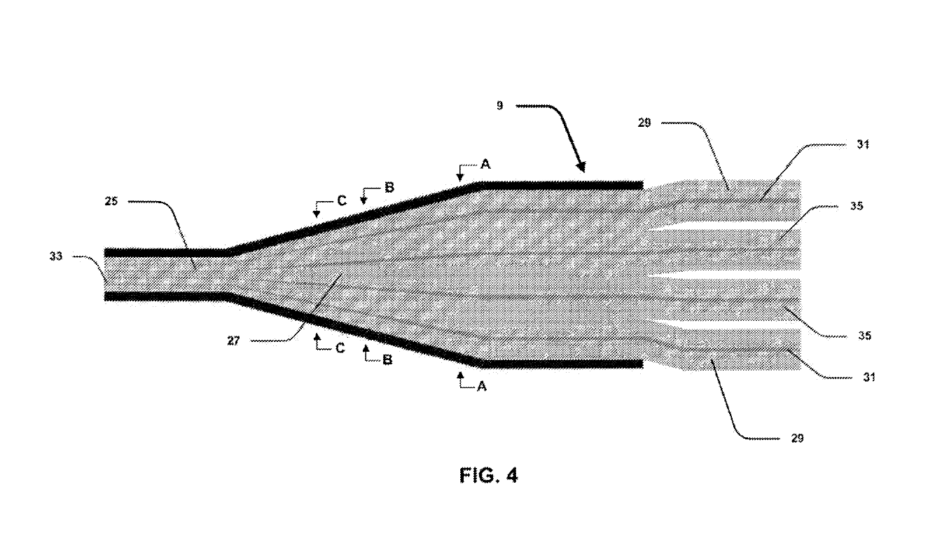

Referring again to FIGS. 1 to 3, the optical signal received in each of the M multi-mode fibres 5 is coupled into N single mode fibres 11 though a photonic lantern 9. This lantern is a recently developed device for efficiently coupling a plurality of unpolarised spatial modes carried by a multi-mode fibre 5 to a corresponding plurality of degenerate single-mode fibres 11. Such a device is schematically illustrated in FIG. 4 and is generally referred to as a “photonic lantern” in the field.

Referring to FIG. 4, the photonic lantern consists of an incident multi-mode fibre section 25 coupled to a bidirectional fibre taper 27 that relies on adiabatic coupling between the multi-mode section 25 and a plurality of single-mode fibre sections 29. The lantern 9 essentially acts as a multi-mode to single-mode converter (or vice-versa) of optical signals.

In the preferred embodiment of FIG. 1, optical signals received by the telescope 3 are first coupled into a length of multi-mode fibre 5 which is in turn coupled into the multi-mode section 25 of the photonic lantern 9. In this embodiment the multi-mode fibre 5 and the multi-mode section 25 are coupled by means such as fusion splicing. In the alternative embodiments of FIGS. 2 and 3, the received optical signals are coupled directly into the multi-mode section 25 of the photonic lantern 9.

In essence, the multi-mode fibre section 25 undergoes a diverging taper transition 27 to an array of single-mode fibres 29. The embedded single-mode fibre cores 31 emerge along the length of the taper 27. At the multi-mode front face 33, the core diameters are sub-wavelength in size and are not able to guide the incoming light. The bulk of the material at the input evolves to form the cladding 35 of the single-mode fibres that emerge from the taper transition 27. At the output, the single-mode fibre sections 29 are distinct and serve to guide the light, and can be connected to conventional photonic devices or spliced to the lengths of single-mode fibres 11.

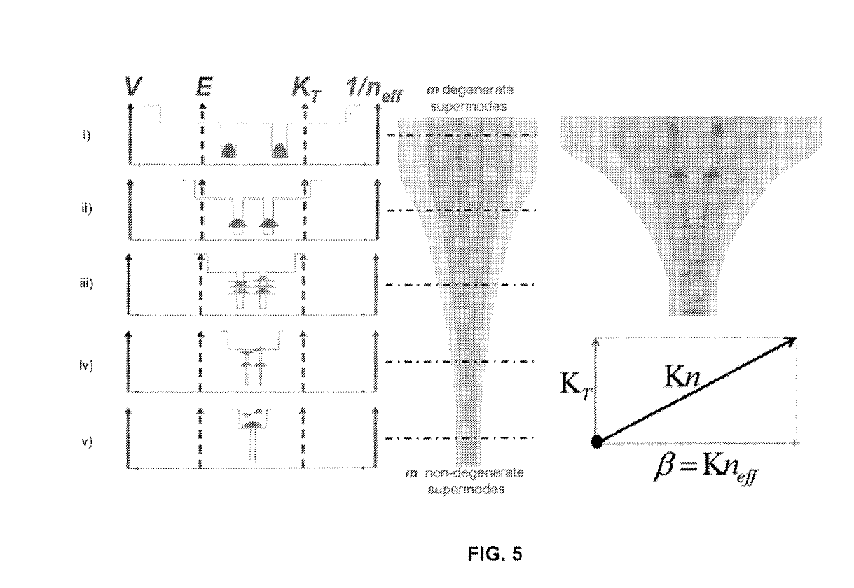

FIG. 5 illustrates the mode propagation principle inside the photonic lantern (incidentally in the reverse orientation from that utilized in the preferred embodiments of the present invention, coupling a number of single-mode signals to a single multi-mode signal). At the start of the transition (panel i), there are m uncoupled single-mode fibre sections 29, each supporting a single spatial mode. These modes evolve through the adiabatic taper 27 to become m electromagnetic spatial modes of the output multi-mode fibre section 25 in a similar manner to the Kronig-Penney model for the interaction of electrons in a periodic potential well. Initially, each quantum well allows only one electron in its lowest energy state (fundamental mode—see panels i and ii). The taper transition renders the quantum wells progressively shallower such that each electron begins to tunnel through its barrier (see panels iii to iv).

With the wells closer together, the leaky “conduction” electrons behave as if confined to a periodic crystal. At the point where the taper ends, the wells have essentially vanished, and the collective behaviour of the electrons is described by m standing waves (cf. supermodes) confined to a single broad potential well (see panel v). Note that the quantum analogy describes the energy eigenstates of an electron, whereas photonics considers the β eigenstates of a photon. The depth of the potential well (V) is equivalent to the reciprocal of the refractive index

$$\frac{1}{{n}_{eff}}$$

of the optical waveguide. The energy eigenstate (E) of the electron is equivalent to the transverse component KT of the wave vector K where the waveguide mode has a propagation constant β=Kn_{eff}.

The efficient coupling is achieved by ensuring that the number of spatial (transverse) modes propagating in the multi-mode fibre section 25 is equal to or less than the number of integrated single-mode fibre portions 29. That is, there is a need to “match” the number of excited modes in the multi-mode section 25 to the number available single-mode sections 29. The number of unpolarised modes supported by the fibre is given by:

$$m \approx \frac{2 {V}^{2}}{{π}^{2}} + 1 \qquad ( 6 )$$

where V is given in equation (5). The transition is highly efficient as long as m is well matched to the number of single-mode fibres on output. This is a statement about the étendue, i.e. area-solid angle (AΩ) conservation of the system, which can be seen by noting the dependence of V² on the cross-sectional area and acceptance solid angle of the fibre. The photonic lantern 9 is an important aspect of achieving a minimum configuration spectrograph.

If the number of single-mode sections 29 is less than the number of spatial modes in the multi-mode fibre section 25, efficient coupling cannot take place due to the insufficient degrees of freedom in the single-mode fibre ensemble.

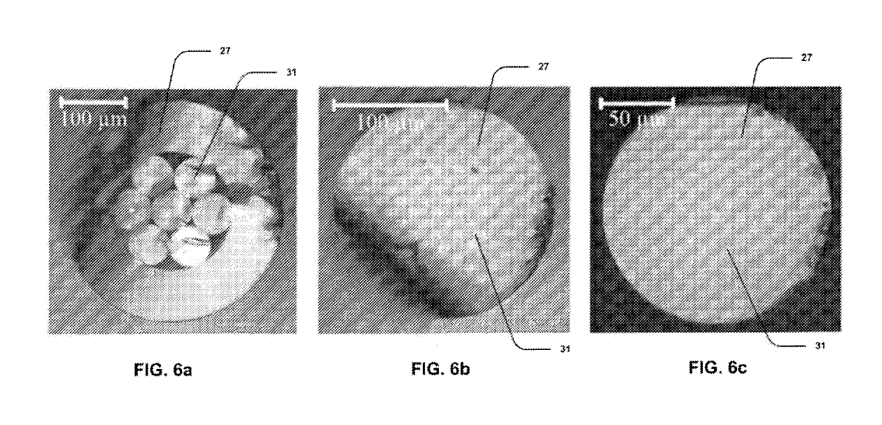

In practice, the photonic lantern 9 is typically fabricated by bundling a plurality of single-mode fibres into a low refractive index glass capillary tube. The tube is then fused and tapered down into a solid glass element. The tapered element will act as a multi-mode waveguide with a core that consists of fused single-mode fibres and a cladding formed by the low index capillary tube. Examples of this tapered fibre bundle along different lengths of the taper are shown in FIGS. 6a to 6c. This method ensures the multi-mode section of the photonic lantern is defined by glass of different refractive index rather than using air-holes. It will be appreciated, however, that other fabrication techniques are possible.

In practice, if efficient coupling is to be achieved between an optical or a near-infrared adaptive optic (AO) focus and a photonic lantern, it must accommodate at least m=7 unpolarized spatial modes even for the best performing systems. More realistically, however, m=40−80 or even a greater number spatial modes are likely to be required.

Single Mode Fibre Propagation

The photonic lantern 9 essentially allows the spectrographic analysis of an arbitrary incident radiation field as a single-mode input. Single mode propagation is a form of light propagation and is diffraction limited. As a result, it is now possible to exploit telecommunication devices that provide arbitrary spectroscopic resolution for a single-mode input. Furthermore, the photonic lantern 9 decouples the requirement that the instrument resolution be dependent on the size of the entrance aperture.

The light output from the photonic lantern 9 is coupled to a plurality of single-mode fibres. These fibres can be arbitrarily long with very little loss along the fibres. In the preferred embodiment these fibres are arranged in a ribbon cable 37, as shown in FIGS. 2 and 3. In these embodiments, use of a ribbon cable 37 arrangement provides for a very high packing density along the diffraction slit 7. While not shown, ribbon cables 37 can also be implemented into the embodiment of FIG. 1.

At this point in the system it is possible to insert various optical elements to manipulate the single-mode optical signals. As shown in FIGS. 1 to 3, an OH suppression fibre Bragg grating 39 is inserted into the optical path. In alternative embodiments, other optical devices or elements performing various optical or photonic functions can be easily inserted into the optical path at various locations in the system. For example, fibre Bragg gratings, frequency laser combs, or other integrated circuits can be incorporated into the optical system.

Array Wave Guide

In the preferred embodiment of FIG. 1, light from the M stacked arrays of N single-mode fibres 11 is coupled into M stacked array waveguide gratings 13. These gratings include a dispersing medium 41 for dispersing each of the N single-mode signals, a plurality of different length tracks 43 for guiding the dispersed signals and a combining medium 45 for combining the signals from each group of N single-mode fibres 11. The array waveguide grating 13 acts as a multiplexer of the individual single-mode optical signals resulting in the single-mode signals being combined into a continuous spectrum at the detector 15.

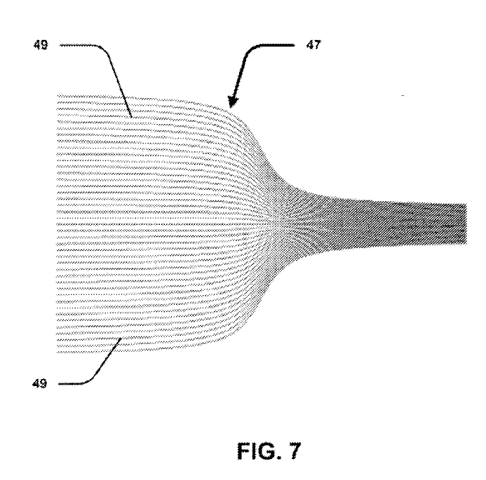

In the alternative embodiments shown in FIGS. 2 and 3, the ribbon cable 37 is compressed via an incoherent array waveguide 47 (shown in FIG. 7 but not shown in FIGS. 2 and 3), which feeds the diffraction-limited slit 17. The incoherent array waveguide 47 also includes a plurality of tracks 49 tapered in spacing for guiding the single-mode signals and condensing them for transmission through the diffraction slit 17. In both the array waveguide grating 13 and incoherent array waveguide 47, the tracks 43 and 49 are well matched to the diameter (10 μm) of the single-mode fibre cores 31 and, in the latter case, to the width of the diffraction-limited slit 17.

In some embodiments, the inputs to the incoherent array waveguide 47 are spaced apart (pitched) by a distance of one free spectral range (one spectral order). The free spectral range is the spacing (in wavelength or frequency) between adjacent spectral peaks of an interference or diffraction image. In alternative embodiments, various other spacings of the incoherent array waveguide inputs can be implemented.

In one embodiment, the tracks 49 are tapered together with a pitch of about 20-30 μm in order to minimize crosstalk such that roughly 10² single-mode fibres are placed along the slit 17. The telecomm standard SMF 28 fibres are well matched to F=4 optics. Therefore ˜10² spatial elements can be dispersed at any spectral resolution up to R˜50,000 in an extremely compact, low cost instrument. In principle, it is possible to pack in more single-mode fibres along parallel slits, but this may reduce the accessible spectral bandpass for each single-mode fibre input. Another important consideration is cross dispersion at high spectral resolution such that multiple orders from each single-mode fibre input are interleaved at the detector.

The single-mode tracks 49 along the incoherent array waveguide can be brought arbitrarily close together. Consider the parallel tracks in FIG. 7 close to the entrance slit. An electric field inserted into the middle track, say, will couple into the two neighbouring tracks over a short distance which can be determined. The (normalised) electric field amplitude E in the n^{th} track (n=0 at centre) at a distance z along it obeys the equation:

$$\frac{d {E}_{n} ( z )}{d z} = - i {kE}_{n - 1} ( z ) - i {kE}_{n + 1} ( z ) - \frac{α}{2} {E}_{n} ( z ) \qquad ( 7 )$$

where α is the attenuation along a single track, and k is the coupling coefficient between the central track and adjacent n=±1 tracks (being negligibly small for non-adjacent tracks). For appropriate boundary conditions, the general solution is

$${E}_{n} ( z ) = {( - 1 )}^{n} {J}_{n} ( 2 kz ) {e}^{- \frac{α}{2} z} \qquad ( 8 )$$

Geometric and material information resides within the constant k. One approximation of this constant is

$$k = \frac{2 {k}_{x}^{2} {q}_{x} {e}^{- {q}_{x} c}}{{k}_{z} w ( {k}_{x}^{2} + {q}_{x}^{2} )} \qquad ( 9 )$$

for which c is the separation between channels, w is the channel width, kₓ and k_{z} are the propagation constants along the x and z axes respectively, and qₓ defines the exponential fall-off in the x direction. The value of k is of order 1 mm⁻¹ but can be increased by an order of magnitude (if needed which is not obviously the case) by moderate reductions in the refractive index contrast Δ between the waveguide tracks 49 and the waveguide substrate. There is a strong dependence of k on Δ through the material propagation constants.

Detector

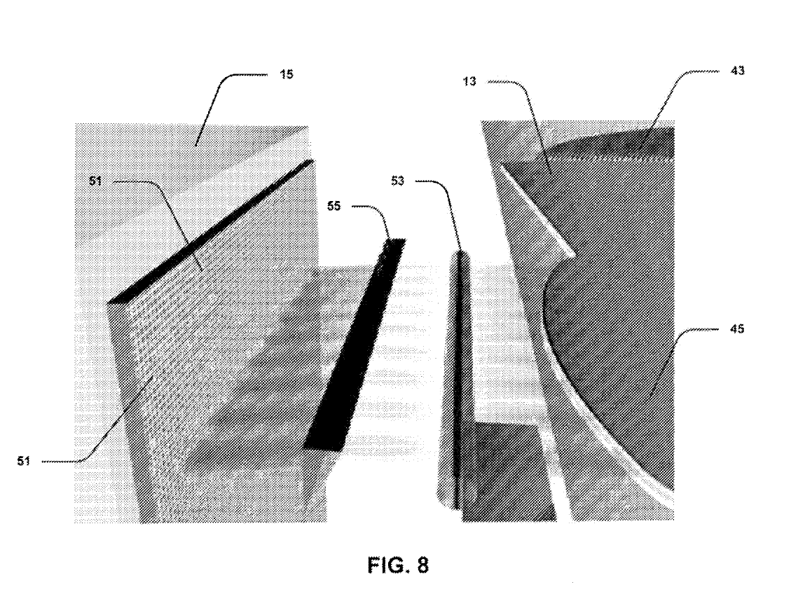

Referring now to FIG. 8, the optical signal exiting the array waveguide grating 13 or incoherent array waveguide 47 is incident on an optical detector 15. In one embodiment the detector is an electronic charge-coupled device (CCD) detector having a two-dimensional array of detectors or pixels 51. However, it will be appreciated that other types of detectors can be used. Using a CCD detector allows the incident optical signal to be easily converted to a corresponding electrical signal for manipulation and display using various electrical devices such as a computer.

To retain the diffraction limited performance at the input slit, achieve the maximum number of combining beams across the pupil (R=M×N), and keep the instrument in its minimal (smallest) configuration, the optimal detector 15 preferably has a pixel size less than about 2 microns. This configuration means that the output f/ratio of the camera is comparable to the input f/ratio of the collimator. Ideally, a very high resolution pixel sensing pitch is used with the detector device. It will be appreciated, however, that in various embodiments, the detector pixels 51 can be any practical size.

In many cases, the amount of information in the pupil dictates the use of small pixels. In some cases, the pupil info can be the biggest effect on the system performance.

In one embodiment the input f/ratio is made to be particularly fast (which provides a short focal length) and it is desired to roughly match that on output. The resultant resolution of the detector 15 is the inverse Fourier transform of all the optical transfer functions produced by each pixel element together.

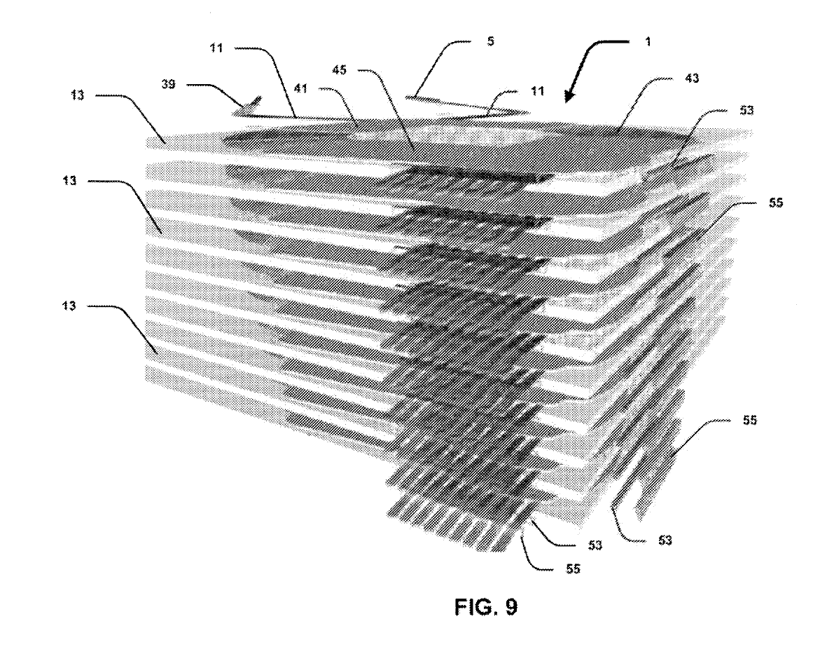

In the preferred embodiment of FIG. 1, the M array waveguide gratings 13 are stacked vertically to output many horizontally dispersed optical signals onto the detector 15. This configuration is shown in FIGS. 8, and 9.

Referring specifically to FIG. 8, the optical signal exiting the array waveguide grating 13 is transmitted through a micro cylinder 53 and a micro prism 55. These elements act to cross-disperse the optical signal thereby spatially separating different spectral bands that may be present within the incident radiation field 7. In this manner, different wavelength bands are detected at separate positions on the detector 15. In other embodiments, various types of optical elements can be incorporated into the system to manipulate the wavefront incident onto the detector 15.

For example, if the free spectral range of the array waveguide grating 13 is 60 nm, and the incident radiation signal has a spectral band that is 180 nm wide, the extra incident bandwidth will be folded back within the 60 nm spectrum at the output. Consider the three bands: band 1 (1400-1460 nm); band 2 (1460-1520 nm); and band 3 (1520-1580 nm). If incident radiation having a spectrum in the range 1400-1580 nm is received by the spectrograph 1, each 60 nm band is combined as a single superimposed 60 nm spectrum at the detector 15.

This situation is greatly reduced by cross-dispersing the signal output from the array waveguide grating 13 with one or more dispersing elements, such as the micro cylinder 53 and micro prism 55. These elements act to spatially disperse the signal by wavelength, thereby separating each spectral band.

In the preferred embodiment, the micro cylinder 53 and micro prism 55 disperse different spectral orders (frequency bands output due to a free spectral range of the array waveguide) vertically onto the detector 15. In this manner, vertically adjacent detector pixels 51 detect adjacent spectral orders of incident radiation 7. This is shown in FIGS. 8 and 9 as different colour signals (wavelengths) dispersed vertically by different amounts.

One consideration is that the cross-dispersion must be restricted such that the output from a first array waveguide does not overlap with the output from a second array waveguide. The cross dispersing prism works for all of the input fibres from the lantern.

For a given number of spectral orders, the two-dimensional detector can be maximally packed with spectral information. Using the above example of 3 spectral orders (that is, an incident radiation field having a bandwidth 3 times wider than the free spectral range of each array waveguide grating 13), in the horizontal direction, there exists N spectra from the N single-mode outputs from each photonic lantern 9. In the vertical direction, there exists 3×M spectra, where M is the number of photonic lanterns and stacked array waveguide gratings. Therefore, in this example, the detector would need to comprise at least an N-by-3M array of detector pixels. In practice, it may be desirable to use many more than 3 cross dispersed orders and, as such, the size of the detector would necessarily need to be upscaled accordingly.

Conclusions

It will be appreciated that the disclosure above provides a photonic spectrograph with a substantially reduced size and mass and has an entrance aperture that is largely independent of the resolving power of the instrument.

This reduced size and weight is achieved by ensuring the diffraction slits matched to the delivered (e.g. seeing-limited) PSF at the focal plane are necessarily large to avoid light loss. Here the angular dispersion (plate scale) P is given by

$$P = 1.72 {( \frac{F}{15} )}^{- 1} {( \frac{{D}_{tel}}{8 m} )}^{- 1} \\ arc sec {mm}^{- 1} \qquad ( 10 )$$

such that for any reasonable seeing (˜0.5″) or AO-corrected PSF achieved to date, the entrance slit is far from being diffraction-limited. However, there are numerous factors that go into designing astronomical spectrographs. For example, wider slits provide a push towards larger optical components which are more difficult to manufacture for diffraction-limited performance. Many systems push hard on the broadband response of the instrument which leads to more demanding collimator and camera elements that need to be cemented to high tolerances to achieve the diffraction-limited performance. These issues are generally found to become much easier with the smaller optics (Dₚ=50 mm) utilized utilised in the present invention.

With the use of the present invention, even an aberrated PSF from an imperfect adaptive optics (AO) system can be efficiently matched to a minimum configuration spectrograph. Other source of incoherent illumination can also be matched to a minimum configuration spectrograph. Furthermore, incoherent light from a fast input beam (F≧2) can be fed to a spectrograph with an arbitrarily high resolving power.

In the present invention, the use of a photonic lantern 9 allows light to be coupled efficiently from fast telescope beams (F˜2) widely exploited by wide-field instruments in addition to slower beams typical of AO systems and small-field telescopes. Remarkably, since the photonic lantern delivers a set of diffraction-limited spots, high-resolution spectroscopy can be carried out for an arbitrarily fast telescope beam and instrument entrance aperture while retaining the extreme compactness of the instrument. A major advantage is that the instrument performance is largely independent of the telescope aperture and can be adopted in any telescope, although ideally the lantern NA should be matched to the focal ratio of the telescope focus, i.e.

$$F = \frac{0.5}{NA} .$$

In particular, the entrance aperture is entirely independent of the resolving power of the instrument. The preferred embodiments also bypass the well-known problems of modal noise in high-resolution spectrographs.

In the embodiments, the Jacquinot limit (a common metric for traditional spectrometers—given by RΩ [symbol] =2π) is greatly exceeded by the use of photonic lanterns. In particular, R≈50,000 and the solid angle accepted by the lantern is given by Ω≈□π(NA)² such R [symbol] Ω=50π□ or an order of magnitude larger than the Jacquinot limit (F=5). In contrast, conventional grating spectrometers have R [symbol] Ω products that are two orders of magnitude less for a disperser with the same area A. This conclusion does, however, overlook the small acceptance area δA of the photonic lantern.

The present invention has wide applications in conventional astronomy. In particular, large fibre bundle formats can be considered for traditional integral field spectroscopy. Because of the transition from multi-mode fibre input to single-mode fibre outputs, it is relatively straightforward to integrate photonic functions like OH-suppressing fibre Bragg gratings, frequency laser combs, or other integrated circuits. In principle, the instrument can be stabilized for high-precision spectrometry such as the measurement of barycentric motion of nearby stars.

Further, the shoebox concept of the embodiments allows small groups and university departments to construct their own instruments for specific “niche” applications at low cost and in short order, without the traditional dependence on major observatory and government laboratories. For example, a compact high-resolution spectrograph is presently being considered to measure the fine structure in the auroral emission above Antarctica.

Further applications have been identified across the broader field of applied physics. In particular, spectrographic applications are found in medical sciences (e.g. high resolving power for isotopes at low light levels), space science (e.g. Mars rovers), atmospheric physics and remote sensing, and the food industry.

In the present invention, almost all of the cost resides in the high-performance detector 15. The spectrograph instrument 1 is modular and relatively low risk (e.g. reduced cryogenics). The instrument is light in weight which greatly facilitates transport between lab and telescope, and between telescopes. Because of its compactness, the spectrograph of the present invention can be mounted close to the telescope focus. This is a low-mass payload which can be launched on high-altitude balloons, remote aircraft, nanosatellites, space vehicles and planetary rovers.

### Interpretation

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, Fig., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical, electrical or optical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A photonic imaging device comprising:
an input port for receiving an arbitrary incident electromagnetic radiation field containing one or more spatial propagation modes;
a coupling device attached to the at least one input port for efficiently coupling the incident electromagnetic radiation field into a plurality (N) of single-mode optical fibres;
an optical manipulation device adapted to receive the optical signals output from the single-mode fibres and selectively combine the single-mode signals into a continuous optical spectrum; and
an optical detector for detecting the continuous optical spectrum.

2. A photonic imaging device as claimed in claim 1, wherein the plurality (N) of single-mode fibres is greater than or equal to the number of spatial modes supported in the incident radiation field.

3. A photonic imaging device according to claim 2, wherein the input port and coupling device together define a photonic lantern having a multi-mode input and N single-mode outputs.

4. A photonic imaging device according to claim 3 further comprising:
a plurality of photonic lanterns arranged in a bundle array, each lantern being coupled to N single-mode fibres; and
a corresponding plurality of optical manipulation devices for respectively combining each group of N single-mode fibres output from each photonic lantern, thereby defining an array of continuous spectra to be detected by the optical detector.

5. A photonic imaging device according to claim 4, wherein the plurality of photonic lanterns and optical manipulation devices are stacked in a vertically disposed array.

6. A photonic imaging device according to claim 3, wherein the optical manipulation device is an array waveguide grating having N input ports.

7. A photonic imaging device according to claim 3, wherein the optical manipulation device further comprises:
a diffraction-limited slit adapted to receive the optical signals output from the single-mode fibres; and
a diffraction grating adapted to receive the optical signals transmitted through the diffraction slit.

8. A photonic imaging device according to claim 7, further comprising an incoherent array waveguide coupled between the outputs of the N single-mode fibres and the input of the diffraction slit for reducing the spacing of the optical signals propagating in the single-mode fibres.

9. A photonic imaging device according to claim 8, wherein the output ports of the incoherent array waveguide are spaced apart by a distance of about one free spectral range.

10. A photonic imaging device according to claim 9, wherein the free spectral range corresponds to a distance of about 2 mm.

11. A photonic imaging device according to claim 1, further comprising one or more dispersing elements inserted between the output of the optical manipulation device and the detector for spatially separating wavelength bands contained within the incident electromagnetic radiation field.

12. A photonic imaging device according to claim 11, wherein the dispersing elements include a micro cylinder and a micro prism.

13. A photonic imaging device according to claim 1, further comprising an OH suppression fibre Bragg grating inserted between the output of the coupling device and the input of the single-mode fibres.

14. A photonic imaging device according to claim 1, wherein the N single-mode fibres are contained in a ribbon cable.

15. A photonic imaging device according to claim 1, wherein the optical detector includes a plurality of individual pixel elements, each having a size of less than about 2 microns.

16. A photonic imaging device according to claim 1, wherein the optical detector is a charge-coupled device (CCD) detector.
